(19) United States
(12) Patent Application Publication
(10) Pub. No.: US 2010/0153675 A1
(43) Pub. Date: Jun. 17, 2010

(54) Management of Native Memory Usage

(75) Inventor: Kiran Kumar, Bothell, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/333,312

(22) Filed: Dec. 12, 2008

(51) Int. Cl. G06F 12/02; G06F 12/00

(52) U.S. Cl. 711/170; 711/E12.001; 711/E12.002

(57) ABSTRACT

Described is a technology in a managed code/native code framework in which native code monitors memory usage (e.g., every fifty frames) to determine when memory usage has increased beyond a threshold. If so, the native memory requests that the managed code perform a garbage collection operation. The managed code may only perform the garbage collection when a sufficient number of objects are ready to be collected. The native code requests additional garbage collection passes be performed in a loop until the managed code decides not to further perform garbage collection, e.g., when not enough objects remain or the number to be collected does not change between collection passes.

### BACKGROUND

In contemporary computing, garbage collection refers to removing objects from memory once those objects are no longer in use. However, in a scenario in which a framework has managed code (e.g., .Net) and native code, the current managed garbage collection operations do not account for the native memory consumed by the native part of the framework. This can be problematic, as the native code's objects use far more memory than the managed code's objects.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which memory usage in native code is monitored to determine when a memory usage condition is reached (e.g., memory usage has increased beyond a threshold). When the condition is reached, the native memory requests that managed code perform a garbage collection operation.

In one aspect, the memory usage is only checked occasionally, such as every fifty frames corresponding to activities that may change memory usage. Further, the managed code may only perform the garbage collection when a sufficient number of objects are ready to be collected.

In one aspect, following an initial garbage collection pass, the native code requests an additional garbage collection pass because the initial garbage collection pass may have made other objects ready to be collected. Additional passes are requested in a loop until the managed code decides not to further perform garbage collection, e.g., when not enough objects remain or the number to be collected does not change between collection passes.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for managed garbage collection of native code's objects.

FIG. 2 is a flow diagram showing example steps taken to manage garbage collection of native code's objects.

FIG. 3 is a state diagram showing example states in performing management of garbage collection of native code's objects.

FIG. 4 shows an illustrative example of a computing environment into which various aspects of the present invention may be incorporated.

### DETAILED DESCRIPTION

Various aspects of the technology described herein are generally directed towards mechanism of controlling garbage collection based on actual native memory usage in a managed code/native code framework. In general, a memory pressure mechanism (algorithm) occasionally checks the use of memory by a native code process, and if memory usage has increased beyond a threshold amount, requests a garbage collection operation.

While Microsoft® Silverlight™ (a cross-platform, cross-browser plug-in that may act as a user interface to a media platform for web content) is an example framework in which managed .Net code and native code are used as examples, it should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing in general.

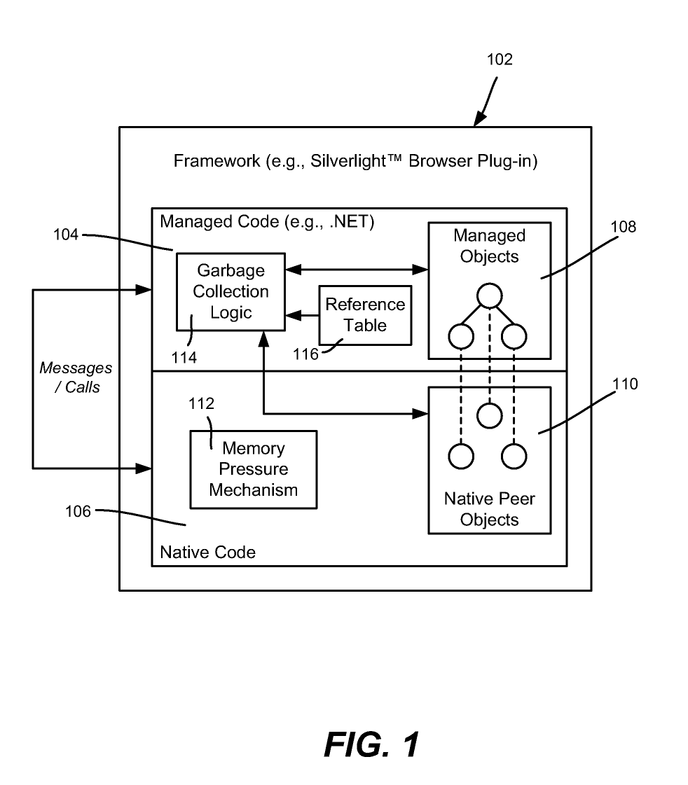

FIG. 1 shows various aspects related to controlling garbage collection based on actual native memory usage in a framework 102 having managed code 104 and native code 106. As is known, as the user code creates objects, the managed code 104 contains managed objects 108, which correspond to native peer objects 110 of the native code 106. In general the managed objects 108 may be on the order of fifty to one-hundred bytes each, whereas the native objects may be on the order of one kilobyte each, whereby the native code memory usage may be substantial, that is, one megabyte per every one hundred native peer objects.

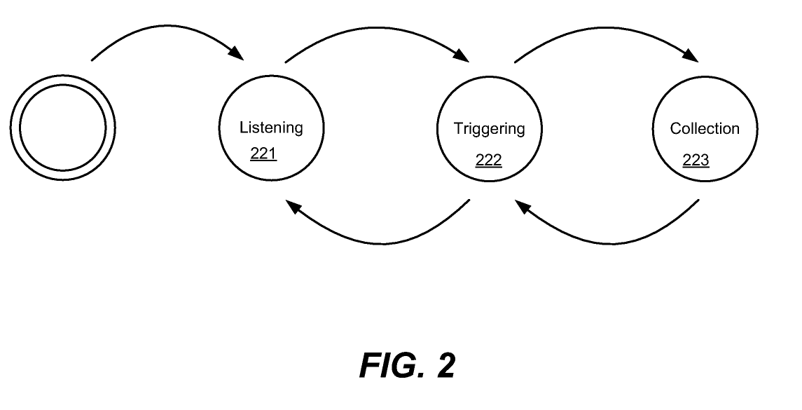

In general, to manage the memory, a memory pressure mechanism 112 (algorithm) starts in a listening state as generally represented by the state 221 of FIG. 2, in which the native side memory usage is tracked. Whenever the current memory usage has increased by some threshold difference amount relative to a previously-used amount, the memory pressure mechanism 112 takes action, including to enter a triggering state 222 in which a collection path is triggered. In one implementation, in this state the native code 106 posts a message (e.g., a Windows® operating system message) for further action. In this message handler it calls up to the managed code 104 requesting that a garbage collection operation be considered. Posting of the message is performed to ensure the asynchronous call and to avoid any thread blocking.

The managed code 104 processes the call and includes garbage collection logic 114 that checks the managed portion of memory (a reference table 116 associated with the managed objects 108 and corresponding native peer objects 110) to determine whether there is a sufficient number of objects to be collected. If not, the memory pressure mechanism 112 goes back to the listening state 221. If so, the garbage collection logic 114 causes those objects to be collected in one pass, and then, because this collection pass may cause more objects to be available for collection, posts an asynchronous message for a next pass; (the memory pressure mechanism 112 goes between a collection state 223 and a triggering state 222 as described below). In the next pass the operation performs another collection if the pending objects to be collected are different from the last collection pass. This loop continues until as also described below until the objects are collected as needed. The memory pressure mechanism 112 then goes back to the listening state 221.

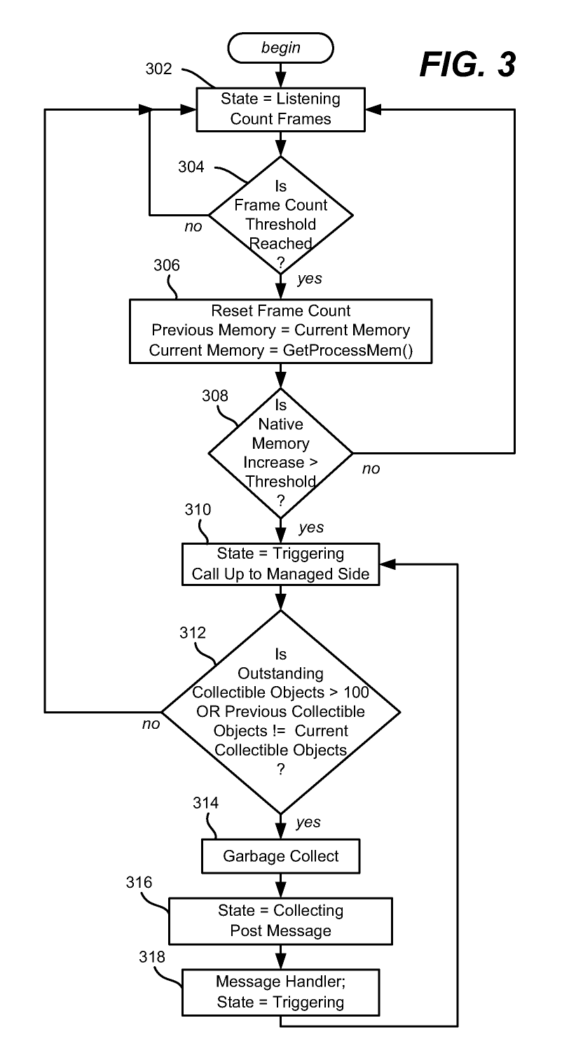

In one implementation, the example steps in the process of FIG. 3 are performed to manage the garbage collection. To this end, once the framework 102 is up and running, the memory pressure mechanism 112 is operated, starting in the listening state 221. In this state, the mechanism 112 occasionally queries the operating system for the current memory size of the process being run. As represented by steps 302 and 304, frames, which are indicative of activity that may change the memory usage are counted, and the query is performed when a threshold number of frames (e.g., fifty, which may be a configurable number) is reached. Note that this query is not performed every frame for performance reasons.

Steps 306 and 308 determine whether the amount of memory being used by the process has increased by a threshold memory increase amount X, (e.g. fifty megabytes, which may be configurable), that is by evaluating the current size compared to the previous size. If so, as represented by step 310, the memory pressure mechanism transitions to the triggering mode 222, where it calls up to the managed side to trigger the possible garbage collection.

In response to the trigger, at step 312 the managed code's garbage collection logic 114 first checks to see if there are more than Y number of objects ready to get collected, (e.g., at least one hundred such objects as tracked in the reference table 116, where Y may be configurable). If not, the collection is not performed, and the memory pressure mechanism returns to the listening state 221. If so, the logic 114 forces a garbage collection (GC.Collect) at step 314, and at step 316 enters a collecting mode (the memory pressure mechanism enters the collection state) and posts a message back to the native code to call back to the managed code.

In the native side, in response to this message, the memory pressure mechanism 112 will post another message to the managed code to ensure that any additional objects that get put into the reference table 116 (as a result of this most-recent garbage collection) can also be collected. Thus, in response at step 318, if the memory pressure mechanism is in the collection state 223 when this message is handled, the memory pressure mechanism returns to the triggering state 222, and calls back via step 310 to the managed code for another garbage collection.

This loop continues until at step 312 the managed side determines that there are no more objects to collect, or the count in the reference table has not changed between the two collections. If either condition is satisfied, the memory pressure mechanism returns to the listening state 221.

In one implementation, another optimization may be included when in the collection/triggering states. Although not explicitly shown in FIG. 3, while in the collection mode, the call up to the managed code at step 310 can be made dependent on frame counts and/or a memory size increase being reached. However, the frame counts and/or memory size need not be the same as those used to initially transition from the listening state. For example, instead of waiting for the X-th (e.g., fiftieth) frame, the memory pressure mechanism may switch to a smaller frame count (e.g., every tenth frame). Similarly, the memory change amount may be reduced from the Y value, e.g., instead of checking for a memory delta of at least fifty megabytes, a delta of ten megabytes may be used. Either or both of these values may be configurable, or may be a configurable ratio, e.g., one-fifth of the X and Y values. Thus, in this example, on every tenth frame, the delta is determined, and if at least a ten megabyte delta is computed, the memory pressure mechanism calls back to the managed code at step 310 to perform a garbage collection. On the managed side, the process repeats via steps 312 and 314 until the reference count is zero or has not changed since the last garbage collection.

### Exemplary Operating Environment

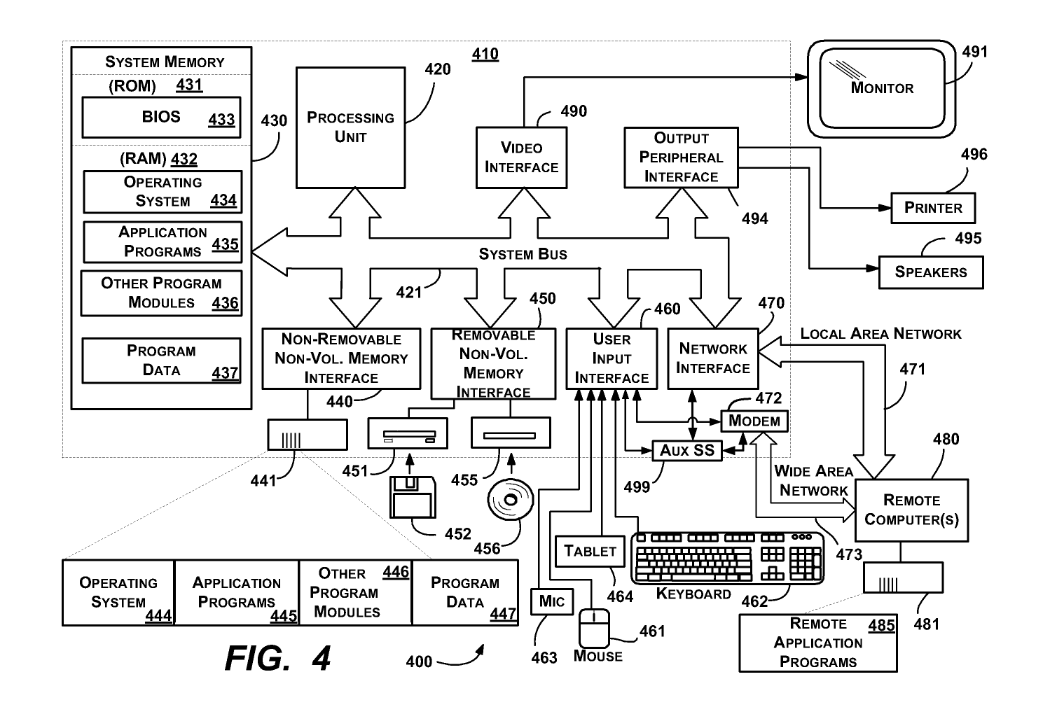

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, monitoring memory usage in native code to determine when a memory usage condition is reached, and upon reaching the memory usage condition, performing an action to trigger a garbage collection operation to collect objects in managed code and native code.

2. The method of claim 1 wherein the native code and managed code correspond to frames in which memory usage may change, and wherein monitoring the memory usage in native code comprises getting a current memory size when a number of frames is reached.

3. The method of claim 1 wherein monitoring memory usage comprises obtaining a current memory size corresponding to the memory usage, evaluating the current memory size against a previous memory size, and reaching the memory usage condition when a threshold size difference is achieved.

4. The method of claim 1 wherein performing the action to trigger the garbage collection operation comprises calling to the managed code.

5. The method of claim 4 wherein the managed code handles the message by determining whether there are a sufficient number of objects to collect, and if so, performing the garbage collection.

6. The method of claim 5 further comprising, notifying the native code of performing the garbage collection.

7. The method of claim 6 wherein the native code calls back to the managed code to request another garbage collection pass.

8. The method of claim 7 wherein the native code waits for a number of frames before the native code calls back to the managed code to request the other garbage collection pass, or computes a memory usage value to decide whether to call back to the managed code to request the other garbage collection pass, or both waits for a number of frames before the native code calls back to the managed code to request the other garbage collection pass and computes a memory usage value to decide whether to call back to the managed code to request the other garbage collection pass.

9. In a computing environment, a system comprising, a framework comprising managed code and native code, the managed code managing managed objects via a reference table and including garbage collection logic that collects objects based upon the reference table, the native code managing native objects corresponding to the managed objects and including a memory pressure mechanism that monitors memory size used by the managed objects, and requests that the managed code perform a garbage collection when a memory size condition is reached.

10. The system of claim 9 wherein the native code monitors the memory size based upon a number of frames being reached, the frames indicative of activities corresponding to possible increased memory usage.

11. The system of claim 9 wherein managed code handles the request by determining from the reference table whether a threshold number of objects are ready to be collected, and if so, performing the garbage collection.

12. The system of claim 11 wherein the managed code performs the garbage collection and posts a message to the native code to indicate performance of the garbage collection.

13. The system of claim 12 wherein the native code handles the message by requesting at least one additional garbage collection be performed by the managed code.

14. The system of claim 13 wherein the native code handles the message by waiting for a number of frames before requesting an additional garbage collection, or computing a memory usage value to decide whether to request an additional garbage collection, or both by waiting for a number of frames before requesting an additional garbage collection and computing a memory usage value to decide whether to request an additional garbage collection.

15. The system of claim 9 wherein the framework comprises a Microsoft® Silverlight™ application, and wherein the managed code comprises .Net code.

16. One or more computer-readable media having computer-executable instructions, which when executed perform steps, comprising:
(a) in a listening state in native code, counting frames until a frame count threshold is reached, and when reached determining whether memory used by the native code has increased a memory size threshold amount, and if not, remaining in the listening state, and if so, going to a triggering state corresponding to step (b);
(b) in a triggering state, requesting that managed code perform a garbage collection, and if managed code does not perform the garbage collection, returning to the listening state of step (a), and if managed code performs the garbage collection, going to a collecting state of step (c); and
(c) in the collecting state, handling a message from the managed code, including determining whether to perform another garbage collection, and if so, returning to the triggering state of step (b).

17. The one or more computer-readable media of claim 16 wherein the managed code determines whether to perform garbage collection based upon a number of objects to be collected.

18. The one or more computer-readable media of claim 16 wherein the managed code determines whether to perform the other garbage collection based a change in a number of objects to be collected.

19. The one or more computer-readable media of claim 16 wherein determining whether to perform the other garbage collection comprises waiting for a number of frames before requesting the other garbage collection, or computing a memory usage value to decide whether to request the other garbage collection, or both waiting for a number of frames and computing a memory usage value to decide whether to request the other garbage collection.

20. The one or more computer-readable media of claim 19 wherein the frame count threshold for going to the triggering state from the listening state is different from the number of frames for going from the collection state to the triggering state, or wherein the memory size threshold amount for going to the triggering state from the listening state is different from the memory usage value for going from the collection state to the triggering state, or wherein both frame count threshold for going to the triggering state from the listening state is different from the number of frames for going from the collection state to the triggering state and the memory size threshold amount for going to the triggering state from the listening state is different from the memory usage value for going from the collection state to the triggering state.
